(19) United States
(12) Patent Application Publication
(10) Pub. No.: US 2008/0258539 A1
(43) Pub. Date: Oct. 23, 2008

(54) WHEEL END WITH COUPLER

(76) Inventor: Jeffrey W. Schumacher, North Canton, OH (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 12/143,457

(22) Filed: Jun. 20, 2008

Related U.S. Application Data
(63) Continuation-in-part of application No. PCT/US2006/048510, filed on Dec. 20, 2006.
(60) Provisional application No. 60/752,743, filed on Dec. 21, 2005.

(51) Int. Cl. B60B 27/00

(52) U.S. Cl. 301/105.1; 384/544

(57) ABSTRACT

A highly compact wheel end (A) for an automotive vehicle includes a housing (2), a hub (4) having a hollow spindle (18) that projects into the housing, and an antifriction bearing (6) located between the housing and the hub spindle. The housing is configured for attachment to a suspension system component (C), whereas the hub has a drive flange (14) for securement of a road wheel (B) The bearing includes an inboard inner race (32) that fits around the hub spindle and has a recess (40) that at least partially receives a formed end (26) at the end of the spindle. In addition, the wheel end has a coupler ring (8) that fits into the inboard end of the spindle and is provided with an enlarged end (52, 86) that projects a short distance from the end of the spindle where it is provided with an external spline (54, 88) for engagement with a slidable clutch ring (66, 90).

### CROSS-REFERENCE TO RELATED APPLICATIONS

This application derives and claims priority from U.S. Provisional Application 60/752,743, filed Dec. 21, 2005, and from International Application PCT/US2006/048510, filed Dec. 20, 2006, and published under International Publication Number WO 2007/073483, which applications are incorporated herein by reference.

### BACKGROUND OF THE INVENTION

This invention relates in general to wheel ends and, more particularly, to a wheel end fitted with a coupler to enable it to be selectively engaged with and disengaged from an axle shaft through which torque is delivered.

The typical wheel end for an automotive vehicle serves to couple a road wheel for the vehicle to a suspension upright, such as a steering knuckle, for the vehicle. As such, it includes a housing that is attached to the suspension upright, a hub to which the road wheel is attached, and an antifriction bearing located between the housing and a spindle on the hub to enable the hub and wheel to rotate with minimal friction. Some wheel ends have splined couplers that enable torque to be transferred selectively to the hub from an axle shaft, but the typical coupler fits around the spindle behind the bearing and significantly extends the length of the wheel end. This makes the wheel end difficult to package, that is to say, it makes the wheel end longer than automotive manufacturers desire for the vehicles.

### BRIEF DESCRIPTION OF THE DRAWINGS

FIG. 1 is a perspective view, broken away and in section, of a wheel end constructed in accordance with and embodying the present invention, with the wheel end being attached to an suspension upright and fitted with an axle end;

FIG. 2 is a longitudinal sectional view of the wheel end; and

FIG. 3 is an enlarged fragmentary sectional view showing the coupler ring of the wheel end fitted to the hub spindle of the wheel end and a clutch ring engaged with the coupler ring; and

FIG. 4 is an enlarged fragmentary sectional view similar to FIG. 3, but showing a modified hub spindle, coupler ring and clutch ring.

### DETAILED DESCRIPTION

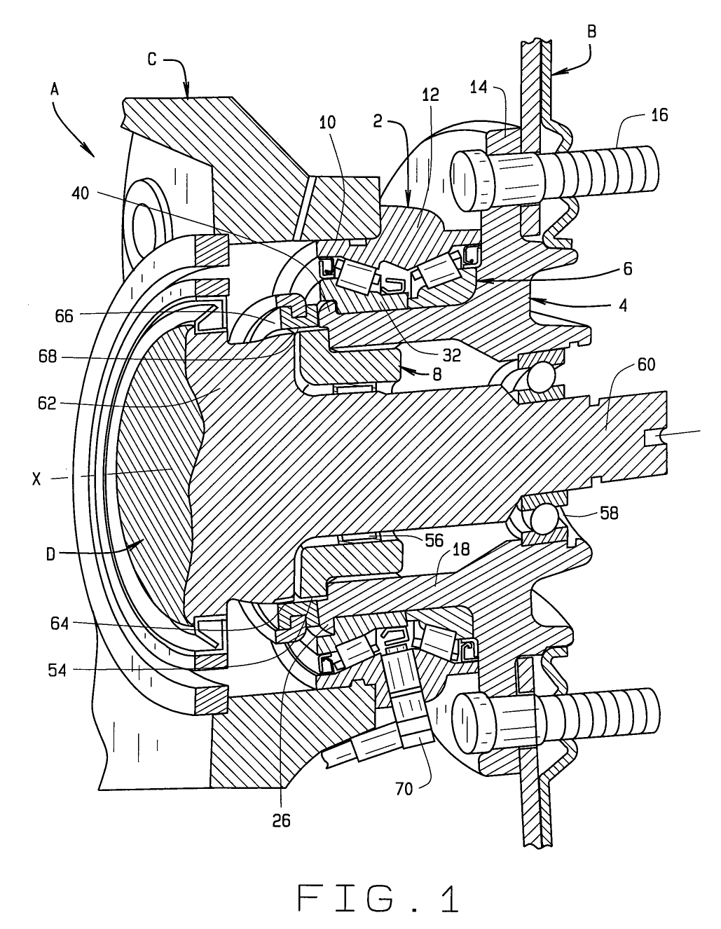

A wheel end A (FIG. 1) couples a road wheel B to a suspension system component C, such as a steering knuckle or other suspension upright, of an automotive vehicle and is further equipped for selective engagement with an axle end D through which torque is delivered to the wheel end A and to the road wheel B on it. The wheel end A basically includes a housing 2 that is bolted to the suspension system component C, a hub 4 to which the road wheel B is attached, and an antifriction bearing 6 located between the housing 2 and the hub 4 to enable the latter to rotate with respect to the former about an axis X. The wheel end A also has a coupler ring 8 at which the hub 4 is selectively engaged with the axle end D.

The housing 2 has a generally cylindrical body 10 and a flange 12 that projects outwardly from the body 10 intermediate the ends of the body 10. The inboard portion of the body 10 fits into the suspension system component C, while the flange 12 fits against the component C and receives bolts that secure the housing 2 to the component C.

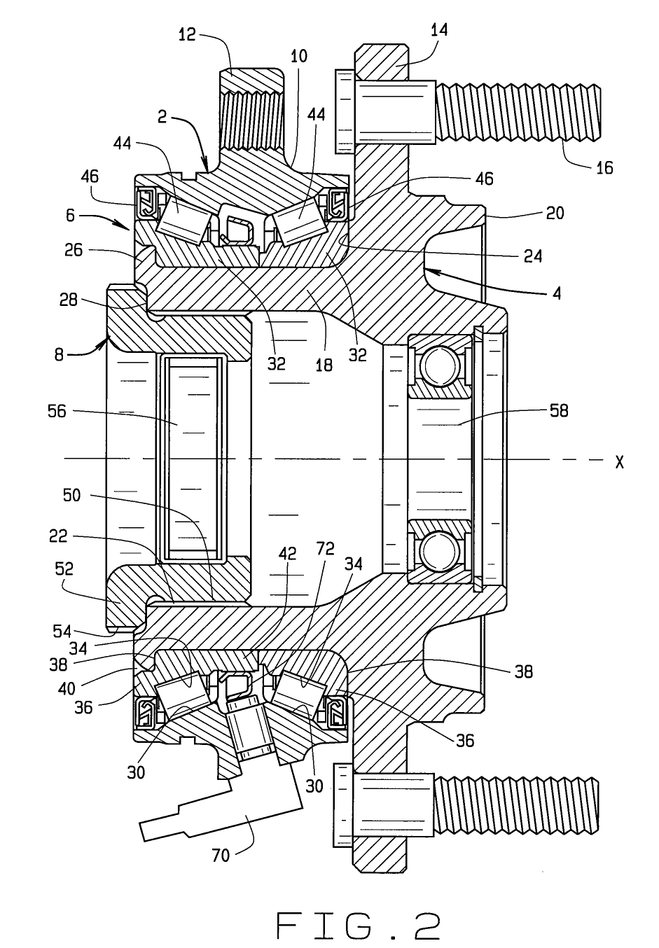

The hub 4 has a drive flange 14 that projects outwardly past the outboard end of the housing 2 and serves as a mount for the road wheel B and for a brake disk or drum as well. They are secured to the flange 14 with lug bolts 16 that project from the flange 14. In addition, the hub 4 has (FIG. 2) a spindle 18 that projects axially into the housing 2 and a wheel pilot 20 that projects axially in the opposite direction. Both the spindle 18 and pilot 20 are hollow. The pilot 20 serves to center the road wheel B on the hub 4. The spindle 18 at the far end of its hollow interior has an internal spline 22. Externally, the spindle 18, where it merges with the flange 14, has a shoulder 24, while its opposite end is deformed outwardly in the provision of a formed end 26 that surrounds a shallow recess 28, to which the internal spline 22 extends. U.S. Pat. Nos. 6,443,622 and 6,532,666 describe processes for upsetting the end of the spindle 18 to provide the formed end 26 and are incorporated herein by reference.

The bearing 6 enables the hub 4 to rotate relative to the housing 2 about the axis X. It includes outer raceways 30 that are presented inwardly toward the axis X and taper downwardly toward each other. They may be internal surfaces on the housing 2 itself. The bearing 6 also includes two inner races in the form of outboard and inboard cones 32. Each cone 32 has a tapered raceway 34 that leads up to a thrust rib 36 at its large end, and the thrust rib 36 in turn has a back face 38 that lies at an angle to the axis X. Indeed, the back face 38 may lie perpendicular to the axis X or oblique to it. The tapered raceway 34 of the outboard cone 32 is presented outwardly toward the outboard outer raceway 30 and is inclined in the same direction. The tapered raceway 34 of the inboard cone 32 is presented outwardly toward the inboard outer raceway 30 and is inclined in the same direction. Thus, the outboard raceways 30 and 34 are inclines in one direction and the inboard raceways 30 and 34 are inclined in the opposite direction. The back face 38 of the inboard cone 32 lies at the end of an annular recess 40 that is within the thrust rib 36 of that cone 32 and hence is offset axially from the actual end of the cone 32. Moreover, the inboard cone 32 at its opposite end has an axially directed extension 42 that leads out to and abuts the corresponding end of the outboard cone 32. The back face of the outboard cone 32 abuts the shoulder 24 where the hub flange 14 and spindle 18 merge. The back face 38 of the inboard cone 32 abuts the formed end 26 of the spindle 18, so the two cones 32 are captured between the flange 14 and the formed end 26. Preferably, the formed end 26 lies entirely within the recess 40 in the formed end 26 and does not project axially beyond either the bearing 6 or the housing 2. However, the formed end 26 may lie only partially in the recess 40. Irrespective of whether the formed end 26 is entirely within or only partially within the recess 40, the wheel end A is highly compact.

In addition to its outer raceways 30 and cones 32, the bearing 6 has rolling elements in the form of tapered rollers 44 arranged in outboard and inboard rows. The rollers 44 of outboard row lie between and contact the outboard raceways 30 and 32, whereas the rollers 44 of the inboard row lie between and contact the inboard raceways 30 and 32. The geometry is such that the rollers 44 are on apex and transfer radial loads between the housing 2 and hub spindle 18 and axial loads in both axial directions as well. The length of the axial extension 42 on the inboard cone 32 determines the setting for the bearing 6, and preferably it is one slight preload, so that no internal clearances exist in the bearing 6.

The annular spaces between the ends of the housing 2 and the cone thrust ribs 36 that lie within those ends are closed by seals 46.

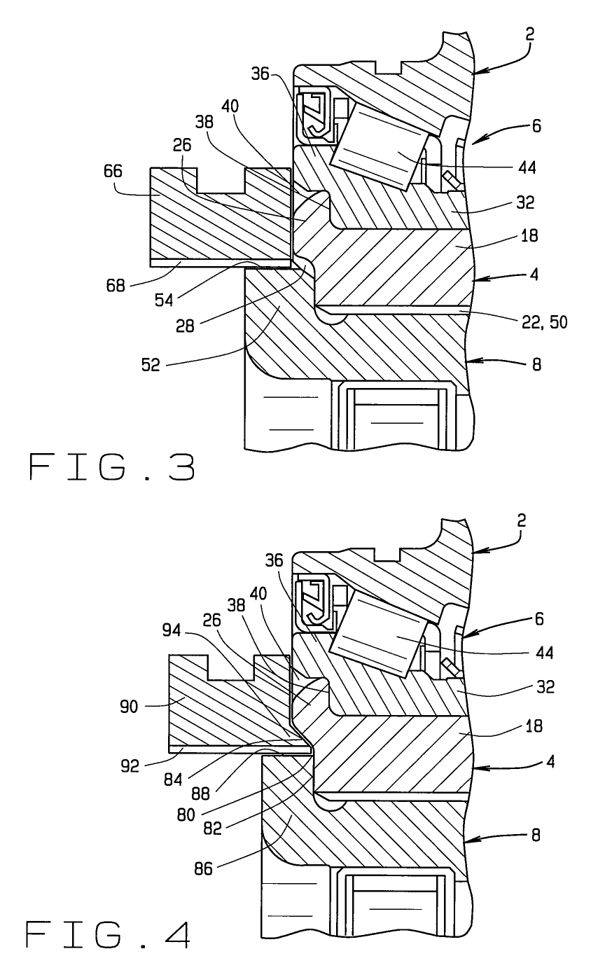

The coupler ring 8 has (FIGS. 2 & 3) an external spline 50 that fits within and engages the internal spline 22 within the inboard end of the hub spindle 18. One of the splines 22 or 50 may be provided with a slight helix to create an interference between the splines 22 and 50. The interference avoids lost circumferential motion between the coupler ring 8 and hub 4 and also prevents the coupler ring 8 from displacing axially in the spindle 18. In the alternative, a snap ring located between the coupler ring 8 and spindle 18 will prevent axial displacement. The external spline 50 of the coupler ring 8 leads out to an enlarged end 52 (FIG. 3) that fits in part within the recess 28 that opens out of the inboard end of the hub spindle 18, but the enlarged end 52 projects out of the recess 28, and here the coupler ring 8 is provided with another and larger external spline 54 that has a diameter less than the diameter of the formed end 26. In the alternative, the enlarged end 52 may extend radially outwardly behind the formed end 26 or even behind the thrust rib 36 on the inboard core 32.

The coupler ring 8 carries a needle bearing 56. The hub 4 at its outboard end carries a deep groove ball bearing 58. The two bearings 56 and 58 align along the axis X.

The axle end D (FIG. 1) projects through the coupler ring 8 and into the hub spindle 18, and may be selectively engaged with the coupler ring 8 to transfer torque to the hub 4. In this regard, the axle end D is coupled to a differential, which in turn is coupled to a transfer case located along the drive train of the vehicle. When the transfer case is engaged with the drive train, torque is delivered to the axle end D. But the axle end D is not always engaged with the hub 4, so that the hub 4 may rotate independently of the axle end D.

The axle end D includes (FIG. 1) a stub shaft 60 which projects into and is supported in the bearings 56 and 58, that are within the hub spindle 18, and an enlarged clutch body 62 from which the stub shaft 60 projects. The clutch body 62 has an external spline 64 that corresponds in size and configuration to the external spline 54 on the coupler ring 8. The clutch body 62 carries a clutch ring 66 having an internal spline 68 that engages the external spline 64 of the clutch body 62, but can easily slide over it. Normally the clutch ring 66 remains retracted entirely around the spline 64 of the clutch body 62. When the clutch ring 66 is so disposed, the hub 4 may rotate relative to the axle end D. The bearings 56 and 58 accommodate this rotation. However, when the clutch ring 66 is displaced axially toward the hub 4, it will also engage the external spline 54 on the enlarged end 52 of the coupler ring 8, in effect bridging the clutch body 62 and the clutch ring 8. With the clutch ring 66 is so disposed, torque will transfer from the axle end D to the hub 4 of the wheel end A and of course power the road wheel B. The position of the clutch ring 66 is controlled by a mechanism that engages it.

The housing 2 may carry a speed sensor 70 that monitors a target wheel 72 fitted to the axial extension 42 on the inboard cone 32. The sensor 70 produces an electrical signal that reflects the angular velocity of the hub 4.

The wheel end A occupies generally no more space than a conventional wheel end with a formed end upset outwardly behind the inboard cone of its bearing. Yet the wheel end A has the capacity for engagement with the clutch ring 66. Much of the compactness derives from the annular recess 40 in the inboard cone 32 and the presence of the formed end 26 in that recess 40.

With slight modifications (FIG. 4) the wheel end A may be made even more compact. The modifications include, at the inboard end of the spindle 18, an annular recess 80 that, while not necessarily being deeper than the recess 40, is wider. To this end, the recess 80 has a back surface 82 that is perpendicular to the axis X and a peripheral surface 84 that is oblique to the axis X and leads from the back surface 82 out to the formed end 26. The coupler ring 8 that fits into the inboard end of the hub spindle 18 likewise has an external spline 50 that engages the internal spline 22 in the spindle 18, but the modified ring 8 otherwise differs in that it has a shorter enlarged end 86. And while the end 86 carriers an external spline 88 that corresponds in cross-sectional configuration to the external spline 54 on the enlarged end 52, it differs in that it occupies essentially the entire length of the enlarged end 86. Indeed, the external spline 88 extends into the recess 80, almost to the back surface 82 of the recess 80.

Finally, the clutch body 62 on the axle end D and the coupler ring 8 in the hub spindle 18 are selectively coupled through a modified clutch ring 90 having an internal spline 92 that remains continually engaged with the external spline 64 on the clutch body 62 and will engage the external spline 88 on the enlarged end of the coupler ring 8 when the clutch ring 90 is displaced toward the inboard end of the hub spindle 18. To this end, the clutch ring 90 has a beveled end 94 which fits into the annular recess 80 in the hub spindle 18—indeed, along the peripheral surface 84 of the recess 80—when the clutch ring 90 is fully displaced toward the hub spindle 18. Of course, in this position the clutch ring 90 unites the axle end D and the coupler ring 8, so that torque will transfer from one to the other.

The outboard inner cone 32 of the bearing 6 may be formed integral with the spindle 18, so that the outboard inner raceway 34 and the thrust rib 36 at the large end of that raceway 34 are surfaces of the spindle 18. Also the outer raceways 30 may be formed on separate outer races, called cups, that fit into the housing, or they both may be located on a single so-called double cup.

The bearing 6 need not be a tapered roller bearing, but instead may be an angular contact ball bearing. Thus, the rolling elements 34 instead of being tapered rollers would be balls. Actually, the bearing 6 may be any type of antifriction bearing having inclined raceways that enable it to transfer both radial loads and axial loads.

Other types of antifriction bearings or even sleeve bearings could be substituted for the ball bearing 58 and needle bearing 56 that receive the stub shaft 60 at the end of the axle end B. In some wheel ends A, a single bearing, preferably at the location of the needle bearing 42, will suffice for supporting the axle end D in the hub 4.

1. A wheel end comprising:
a housing for securement to a suspension system component;
a hub having a flange for mounting a road wheel and also a spindle extending axially from the flange into the housing, the spindle having a formed end spaced from the flange;
an antifriction bearing located between the housing and the hub spindle to enable the hub to rotate relative to the housing about an axis, the bearing including at least one inner race that is located around the spindle and having a back face that is against the formed end, the back face being offset axially from the end of the inner race to provide a recess in which the formed end of the spindle is at least partially received; and
a coupler ring exposed beyond the spindle for being selectively engaged so that torque may be transferred to the hub.

2. A wheel end according to claim 1 wherein the bearing also includes rolling elements arranged in two rows between the hub spindle and the housing, with one of the rows being around the one inner race.

3. A wheel end according to claim 1 wherein the bearing includes outboard and inboard outer raceways carried by the housing and inclined in opposite directions with respect to the axis, an outboard inner raceway presented opposite the outboard outer raceway and inclined in the same direction, an inboard inner raceway present opposite the inboard outer race and inclined in the same direction, and rolling elements located in an outboard row between the outboard raceways and in an inboard row between the inboard raceways; and wherein the inboard inner raceway is on the one inner race.

4. A wheel end according to claim 3 wherein the formed end is located entirely within the recess in the one inner race.

5. A wheel end according to claim 4 wherein the one inner race does not project beyond the inboard end of the housing.

6. A wheel end according to claim 4 wherein the bearing includes another inner race, and the outboard inner raceway is on the other inner race.

7. A wheel end according to claim 6 wherein the one inner race has an axially directed extension that abuts the other inner race.

8. A wheel end according to claim 3 wherein the coupler ring extends into the hub spindle.

9. A wheel end according to claim 8 wherein the coupler ring has an enlarged end that projects axially beyond the hub spindle.

10. A wheel end according to claim 9 wherein the coupler ring and hub spindle are engaged through mating splines.

11. A wheel end according to claim 9 wherein the spindle at its inboard end has a recess that opens axially out of the spindle, and the enlarged end of the coupler ring is received in the recess.

12. A wheel end according to claim 9 wherein the coupler ring on its enlarged end has an external spline.

13. In combination with the wheel end of claim 12, an axle end including a clutch body located beyond the hub spindle and a stub shaft that projects from the clutch body into the coupler ring and hub spindle, the clutch body having an external spline that aligns with the external spline on the enlarged end of the coupler ring.

14. A wheel end according to claim 1 wherein the hub spindle is hollow at its inboard end and the coupler ring fits into the hollow interior of the hub spindle and projects out of the inboard end of the hub spindle, where it has an enlarged end; and wherein the enlarged end has an external spline.

15. A wheel end according to claim 14 wherein the hub spindle has a recess at its inboard end, and the recess in the hub spindle receives the enlarged end of the coupler ring with the enlarged end further projecting out of the recess.

16. A wheel end according to claim 15 wherein the external spline on the enlarged end of the coupler ring lies beyond the inboard end of the hub spindle.

17. A wheel end according to claim 15 wherein the external spline on the enlarged end of the coupler ring lies within and also axially beyond the recess in the hub spindle.

18. A wheel end according to claim 17 and further comprising a clutch ring having an internal spline engaged with the external spline on enlarged end of the coupler ring and also having an end that projects into the recess in the hub spindle.

19. A wheel end according to claim 18 wherein the end of the clutch ring is beveled.
